(19) United States
(12) Patent Application Publication
(10) Pub. No.: US 2026/0186892 A1
(43) Pub. Date: Jul. 2, 2026

(54) SYSTEM AND METHOD TO USE PROCESSOR PERFORMANCE DATA TO PROVE CORRECT AND INTENDED EXECUTION OF CODE AND CODE PATHWAYS ON AN ELECTRONIC DEVICE

(71) Applicant: James Farley WARNE, Arlington, VA (US)

(72) Inventor: James Farley WARNE, Arlington, VA (US)

(21) Appl. No.: 19/436,440

(22) Filed: Dec. 30, 2025

Related U.S. Application Data
(60) Provisional application No. 63/740,271, filed on Dec. 30, 2024.

(51) Int. Cl. G06F 11/07; G06F 11/34

(52) U.S. Cl. CPC G06F 11/0793; G06F 11/0772; G06F 11/3447

(57) ABSTRACT

In an embodiment, a first compute device includes a memory and a first processor operatively coupled to the memory. The first processor is configured to send instrumented code to a second compute device that includes a second processor to cause the second processor to execute the instrumented code and generate performance data of the second processor. The instrumented code is generated based on un-instrumented code. The first processor is further configured to determine a status of the instrumented code based on the performance data, where the un-instrumented code has the status of the instrumented code.

### CROSS-REFERENCE TO RELATED APPLICATION

This application claims priority to U.S. Provisional Patent Application No. 63/740,271, titled “SYSTEM AND METHOD TO USE PROCESSOR PERFORMANCE DATA TO PROVE CORRECT AND INTENDED EXECUTION OF CODE AND CODE PATHWAYS ON AN ELECTRONIC DEVICE” and filed Dec. 30, 2024, the contents of which are incorporated herein by reference in their entirety.

### FIELD

One or more embodiments are related to a system and method to use processor performance data to prove correct and intended execution of code and code pathways on an electronic device.

### BACKGROUND

A device can execute code. The code, however, may be modified and/or otherwise execute improperly at the device. This can lead to, for example, a malfunction, breach, or otherwise undesirable performance. Accordingly, proving correct and intended execution of code and code pathways on a device can be desirable.

### SUMMARY

In an embodiment, a non-transitory, processor-readable medium stores code that, when executed by a first processor of a first compute device, causes the first processor to generate, based on first un-instrumented code, a map that represents a plurality of executions of a second processor included in a second compute device. The non-transitory, processor-readable medium further stores code that, when executed by the first processor, causes the first processor to instrument the first un-instrumented code to generate first instrumented code. The non-transitory, processor-readable medium further stores code that, when executed by the first processor, causes the first processor to send the first instrumented code and the map to the second compute device. The second processor is configured to execute the plurality of executions based on the map to generate performance data associated with the second processor. The non-transitory, processor-readable medium further stores code that, when executed by the first processor, causes the first processor to receive the performance data associated with the second processor from the second compute device. The non-transitory, processor-readable medium further stores code that, when executed by the first processor, causes the first processor to generate a model based on the performance data associated with the second processor. The non-transitory, processor-readable medium further stores code that, when executed by the first processor, causes the first processor to send second instrumented code to a third compute device that includes a third processor configured to execute the second instrumented code and generate performance data associated with the third processor. The second instrumented code is generated based on the second un-instrumented code. The non-transitory, processor-readable medium further stores code that, when executed by the first processor, causes the first processor to determine a status of the second instrumented code based on the model and the performance data associated with the third processor. The second un-instrumented code has the status of the second instrumented code.

In an embodiment, a first compute device includes a memory and a first processor operatively coupled to the memory. The first processor is configured to send instrumented code to a second compute device that includes a second processor to cause the second processor to execute the instrumented code and generate performance data of the second processor. The instrumented code is generated based on un-instrumented code. The first processor is further configured to determine a status of the instrumented code based on the performance data, where the un-instrumented code has the status of the instrumented code. The first processor is further configured to detect an anomaly indicating that execution of the instrumented code is anomalous and does not match an intended or safe execution of at least one of the instrumented code or the un-instrumented code. The first processor is further configured to, in response to detecting the anomaly, perform a remedial action at at least one of the instrumented code, the un-instrumented code, or the second compute device.

In an embodiment, a method includes receiving, via a processor of a first compute device, first code. The method further includes generating, via the processor and based on the first code, a map that represents a plurality of executions of a second compute device. The method further includes instrumenting, via the processor, the first code to generate instrumented code. The method further includes sending, via the processor, the instrumented code and the map to the second compute device. The second compute device is configured to execute the plurality of executions in response to receiving the instrumented code and based on the map to generate performance data. The method further includes receiving, via the processor, the performance data from the second compute device. The method further includes generating, via the processor, a model based on the performance data. An anomaly at a third compute device is detectable based on the model.

### BRIEF DESCRIPTION OF THE DRAWINGS

FIG. 1 illustrates a system block diagram of a system that can use performance data to prove correct and intended execution of code and code pathways on a device, according to an embodiment.

FIGS. 2A-2D illustrate a block diagram of a training system, according to an embodiment.

FIGS. 3A-3B illustrate a block diagram of a live system, according to an embodiment.

FIG. 4A illustrates a block diagram of a live system, according to an embodiment.

FIG. 4B illustrates a block diagram of a training sequence, according to an embodiment.

FIG. 5 illustrates a flowchart of a method to determine a status of instrumented code, according to an embodiment.

FIG. 6 shows a flowchart of a method to generate a model, according to an embodiment.

FIG. 7 illustrates a flowchart of a method to generate and use a model, according to an embodiment.

FIG. 8 illustrates a flowchart of a method to perform a remedial action in response to detecting an anomaly, according to an embodiment.

FIG. 9 illustrates a flowchart of a method to generate a model based on performance data, according to an embodiment.

### DETAILED DESCRIPTION

In some implementations, “map” refers to a collection of inferences and constraints that, if followed, allow guided execution to different parts of the executable code.

In some implementations, “states” refer to the representation of the actions the processor has taken executing a block of code as an aggregated measurement.

In some implementations, “telemetry” (sometimes referred to herein as “performance data” or “processor performance data”) refers to the collection of hardware performance counters (HPCs) into States.

In some implementations, a “StateFlow” refers to a collection of states linked together to represent the state of the processor during advancing execution of the process.

In some implementations, “Gneiss” refers to a system using HPCs to detect deviations from normal operation.

In some implementations, “devices” refer to sensors, systems, control modules, embedded systems, and/or the like that Gneiss can monitor.

In some implementations, “flash” refers to the process of installing firmware onto hardware so that the device, when activated, executes the firmware.

In some implementations, “agent” refers to code running on a monitored device that sends telemetry from the device being monitored to the analysis server.

In some implementations, “basic-block” refers to a collection of instructions (e.g., in code) smaller than individual functions and sometimes terminated by jump or return instructions.

In some implementations, “dataflow coverage” refers to combining dataflow and code coverage that helps guide a fuzzing inspired characterizer through all possible execution pathways, ensuring a complete model.

In some implementations, “dataflow” relates to a representation of computations as a directed graph, where nodes are computations and data flow are the edges.

In some implementations, “code coverage” refers to a percentage measure of the degree to which the source code of a program is executed when a particular test suite is run. A program with high code coverage has more of its source code executed during testing, which suggests the program has a lower chance of containing undetected software bugs compared to a program with low code coverage.

In some implementations, “fuzzing” refers to automated software testing technique that involves providing invalid, unexpected, valid, or random data as inputs to a computer program that is then monitored for exceptions such as crashes, failing built-in code assertions, or potential memory leaks.

In some implementations, “firmware” refers to code flashed onto the read-only memory of a device.

In some implementations, “software” is the programs and other operating information used by a computer.

In some implementations, “machine readable code” refers to the architecture specific code that is generated after compilation.

Some implementations are related to the use of processor performance data to prove correct and intended execution of code and code pathways on an electronic device. This processor performance data can be used to determine the performance characteristics of code, for example, in a performance-critical application on a specific processor and processor architecture. In some implementations, these performance characteristics are used to prove that the code being executed by the processor is the intended code and code pathways. Some implementations use a processor state, sometimes referred to herein as “state,” which is a collection of various processor measures taken each basic-block and stored in a datagram. The datagram can be unique in format (e.g., due to using a collection of hardware measures combined together in a structure to represent an instantiation of the state of a processor while executing a process) and/or from other datagrams (e.g., because each datagram is measured and exists as the only version of itself). This notional state is connected and ordered with other states that stem from the same process on the same machine to create a “flow of states,” sometimes referred to herein as a StateFlow. A collection of models (e.g., statistical models) based upon StateFlow data collected from known-good, fully characterized electronic devices will be used as a baseline/source of truth for expected processor states during the execution of known code pathways. In some implementations, electronic devices being monitored will have the execution states of each process reported to the monitoring system so that they can be compared against the model of expected processor states on the device.

Some implementations are related to using support-vector machine (SVM) stochastic gradient descent (SGD) z-scores of delta on processor performance measures and the p-value of the Mahalanobis distance on collected telemetry to observe correctness. In some implementations, when determining if an individual state collected from the StateFlow of an executed process falls within the parameters of expected execution, a SVM using SGD is used to make the final truth decision. The SVM using SGD can be provided with a corpus of known good data with one or more of the following values: z-scores of each processor performance counter for the difference of the current state with its previous state and/or the p-value of the Mahalanobis distance of the same deltas together as a multivariate measure.

Some implementations determine correctness of execution by (i) deriving one or more feature values from collected processor-performance telemetry (for example, feature values computed from per-state deltas between successive states in a StateFlow), and/or (ii) applying a learned decision function to the feature values to classify an observed state (or an observed sequence of states) as expected or anomalous. In some implementations, the derived feature values include normalized counter-delta features (e.g., z-scores of deltas of one or more processor performance counters) and/or a multivariate distance feature computed over such deltas (e.g., a Mahalanobis distance and an associated significance value). In some implementation, a supervised classifier trained on a corpus of known-good telemetry is applied to the derived feature values to produce a final decision as to whether an individual state from a StateFlow falls within parameters of expected execution; for example, the supervised classifier can include a support-vector machine trained using stochastic gradient descent. In some implementations, the learned decision function can be implemented using a different supervised, semi-supervised, or unsupervised model, thresholding logic, or an ensemble thereof, while preserving the same telemetry-to-feature-to-decision pattern.

In some implementations, processor performance states are connected into and consolidated into a C-structure representing the processor state during execution. In some implementations, processor performance states are associated to one another by matching device and individual process. In some implementations, these matched states are placed in sequence in a collection such as a vector, array, or linked list for processing.

Some implementations are related to StateFlow correlation by process linkage. For instance, process A is only ever seen after Process B or C (e.g., as outlined in a relationship graph). If Process A is seen and its parent process wasn't process B or C, a remedial action can occur (e.g., generate an alert).

Some implementations are related to constraining input grammars for grammar-based fuzzing utilizing program analysis methods such as Single Static Assignment (SSA) and Constraint Solving to generate data coverage maps and coverage guidance. In some implementations, developing a full model includes executing a plurality of pathways (e.g., every possible pathway) on a device and/or a plurality of sequences of pathways (e.g., every possible sequence of pathways) on a device. Some implementations can do this on a physical device. Fuzzing software is a discipline that endeavors to do this to find potential crashes and other various software flaws so that developers may fix their software before the errors occur in the wild/in public/after product release or are utilized by malicious actors. Some implementations can use tools and techniques from fuzzing to efficiently execute pathways on a device. Some implementations can use additional techniques from formal methods such as SAT Solving. Some implementations can use program analysis such as constraint solving and Single Static Assignment to further improve efficiency and guarantee coverage.

Some implementations are related to monitoring of device function/behavior using processor performance data. Some implementations are related to security monitoring of device and system information and functions such as monitoring execution for topics such as hijacked processes.

In some implementations, processor StateFlows are displayed. For example, if all of the states executed were laid out (e.g., displayed), and if a process has been hijacked or is performing unexpectedly, a chance exists that the process will be executing an abnormal number of basic blocks. Thus, there would be a fewer or greater number of basic blocks compared to a normal version of the code. If all the states were lined up, the wrong size could be determined by visual inspection.

Some implementations are related to automated anomaly detection for processor-based information. In some instances, this information can identify abnormal or incorrect device execution or function, including security incidents. In response to detecting an anomaly, a remedial action can be performed.

Some implementations are related to the detection of processing anomalies based on relationship graphs (e.g., indicating relationships between processes and when a certain process(es) should follow or precede a certain other process(es)). Some implementations relate to an analytic framework that combines multiple sources of information and security knowledge to detect abnormal execution, potential threats, and potential malfunction. In some examples, the input can be anomaly events, regular events in anomalous context, or simply regular events. The non-processor data associated with the StateFlow can be precisely correlated and assessed.

Some implementations use processor telemetry data to determine execution details of processes. Some implementations are related to a characterizer that generates correct models for all execution paths by utilizing fuzzing and constraint solving state of the art. Some implementations are related to the use of processor telemetry to prove correct execution of the code running on the machine. Some implementations are related to the injection of (e.g., by a compiler, such as a Low Level Virtual Machine compiler) and colocation of monitoring code into code at compile time. Some implementations are related to the injection of processor telemetry reading code into processes under test/examination. Some implementations are related to an automated training, fuzzing, and patching approach for processor telemetry gathering.

Some implementations are related to data cleaning for multivariate data of unknown size. Some implementations are related to the use of a SVM-SGD machine learning model on processor telemetry data.

Some implementations include a training component and live component.

### System During Inference Phase After Training

In some implementations, a live component (sometimes referred to herein as “operating system,” “operating component,” “live system” or “execution system”) executes repeatedly (e.g., continuously, periodically, sporadically) in a client environment. In some implementations, a user (e.g., a monitoring user, site manager, technician) can check the Gneiss Interface to view alerts, upload layouts/blueprints, onboard new devices, map the new devices (e.g., so technicians know where in space they need to go to remediate), and view other data sources. In some implementations, the user can receive alerts (e.g., at their user device) from an alerting system(s) even if the user is not actively monitoring the interface. In some implementations, the user can be assigned actions to mitigate or remediate any identified problems. In some implementations, enrichment and alert databases provide alert and enriched information to the user interface for the user. In some implementations, non-Gneiss-specific telemetry captured from the devices in the client environment and the network traffic the devices generate populates the enrichment database. In some implementations, the alert database holds device outlier alerts generated by an outlier detector, comparing execution between running processes and the trained models. In some implementations, the flow assembler will aggregate the states captured, associate them as flows, and order them by process as ingested from the message queue. In some implementations, the message queue receives individual enriched states from a telemetry aggregator. The telemetry aggregator receives information sent from sensors, embedded systems, and/or control systems.

In some implementations, the trained model is a machine learning model. The trained model can be trained using baseline information to detect anomalies. In some implementations, statistical analysis is performed to collect baseline information. The baseline information can be, for example, aggregated and used with stochastic gradient descent within a support-vector machine to convert the baseline information into a representation of the baseline.

In some implementations, a compute device(s) includes the following components and/or performs the following functions, which could be implemented in hardware and/or software: (1) instrumentation; (2) deployment; (3) on-device operation; (4) processing; (5) alerting. Note that steps (1) to (67) are described below for the instrumentation, deployment, on-device operation, processing, and alerting but do not indicate a strict ordering; said differently, the sequence of (1) to (67) can be followed in one implementation, but the sequence for performing (1) to (67) can vary in other implementations.

### Instrumentation

(1) In some implementations, during compilation, a compiler generates the machine-readable code for the specific architecture on which the code will execute. Some compilers use a lifted language to ensure that, regardless of the target architectures, some or all features of the compiler only need to be written once with the intermediate language and will be applied to supported architectures.
(2) In some implementations, Gneiss can be used if the firmware is built so that measurement instrumentation is injected throughout the firmware. In some implementations, as used herein, the terms “software,” “firmware,” and “code” can be used interchangeably.
(3) In some implementations, Low Level Virtual Machine (LLVM) compiler uses a lifted language or intermediate representation (e.g. LLVM-intermediate representation (IR), sometimes called LLVM ByteCode), as an intermediate step to ensure that the LL VM compiler's improvements (e.g., optimizations) and passes are architecture agnostic.
(4) In some implementations, Gneiss' instrumentation is written into an LL VM compiler pass that injects the monitoring sequence (6) as LL VM-IR into the code to be monitored. After being added to the target code's LLVM-IR, the newly instrumented code (LLVM-IR) is compiled into the target architecture, allowing the compiled newly instrumented code to run on the system being monitored.
(5) In some implementations, first, the firmware is output as LL VM-IR or ByteCode.
(6) In some implementations, second, the firmware is instrumented with a compiler toolchain component that applies an instrumentation pass.
(7) In some implementations, thirdly, the instrumented LLVM-IR is linked and compiled into an executable of the correct architecture using, for example, Clang (a compiler front end) to yield the final executable/binary (machine readable code).

### Deployment

(8) In some implementations, the instrumented code is installed on the system being monitored using the method recommended and supported by the hardware manufacturer.
(9) In some implementations, the system being monitored is placed on and added to the network in the manner recommended by the manufacturer.
(10) In some implementations, the operators will configure the Gneiss Server to communicate alerts and notifications to monitoring personnel and their compute device(s).
(11) In some implementations, if the device is purely firmware and cannot be accessed remotely, the on-device agent must be configured during build, prior to (9), to reach the on-site Gneiss server(s), providing processing and alerting capabilities before installation on the device.
   On-Device Operation (i.e., Operation of the System being Monitored)

### Gneiss Agent

(12) In some implementations, when the device turns on, the local Gneiss Agent ensures a pipe, or functionally similar communication channel exists between the Gneiss Agent and other processes on the device, thus enabling telemetry collection from all processes on the system being monitored running code.
(13) In some implementations, the Gneiss agent then binds to a socket (or uses another device provided communication mechanism) and establishes means for connection to the analysis server. In some implementations, the analysis server and Gneiss agent are at different compute devices; in some implementations, the analysis server and Gneiss agent are at the same compute device.
(14) In some implementations, individual processes running on the device provide telemetry into the pipe via the aforementioned instrumentation. The Gneiss Agent repeatedly (e.g., continuously, sporadically, periodically) reads from the telemetry pipe.
(15) In some implementations, collected states are read from the telemetry pipe, aggregated with other States that will fit in a single datagram for the manufacturer-supported communication channel, and sent off of the system being monitored for analysis.

### Instrumented Processes

(16) In some implementations, as the device executes, each process or facsimile reports its states as it executes (e.g., the process telemetry is written to a pipe (or equivalent) and is read by the Gneiss agent, which sends the read process telemetry off the system being monitored to the analysis server).
(17) In some implementations, at the start of execution, before the execution of the un-instrumented main(), the instrumentation described in (18)-(21) is emplaced.
(18) In some implementations, a global struct available for instrumentation during the lifetime of the process is created.
(19) In some implementations, hardware performance counters (HPCs) for the process are initialized.
(20) Some implementations ensure there are no errors in beginning measurement of the running process. Error handling is performed to verify that the measurement instrumentation was enabled correctly and prevent/mitigate instability in the system being monitored.
(21) In some implementations, begin executing the top of the ‘main()’ function in the pre-instrumentation device firmware.
(22) In some implementations, following the setup sequence (described in (18) to (21)), each subsequent basic-block will have the same instrumentation unless the basic-block is the final basic-block in that execution of the process (such terminating basic-blocks contain exit instructions or the return from main described in (23)-(29)).
(23) In some implementations, the original source code basic-block executes at the system being monitored.
(24) In some implementations, enabled HPCs are toggled off at the system being monitored.
(25) In some implementations, HPC registers are read at the system being monitored.
(26) In some implementations, HPC register values are written to the global state struct at the system being monitored.
(27) In some implementations, the global state struct is written to the telemetry pipe established/maintained in (12) at the system being monitored.
(28) In some implementations, enabled HPCs are toggled on at the system being monitored.
(29) In some implementations, execution continues to the following source code basic-block at the system being monitored.
(30) In some implementations, the instrumentation injected to handle “process exits” at the system being monitored is described in (31)-(38).
(31) In some implementations, the final non-exiting source block executes at the system being monitored.
(32) In some implementations, enabled HPCs are toggled off at the system being monitored.
(33) In some implementations, HPC registers are read at the system being monitored.
(34) In some implementations, HPC register values are written to the global State struct at the system being monitored.
(35) In some implementations, the global State struct is written to the telemetry pipe/established/ maintained in (12) at the system being monitored.
(36) In some implementations, the ‘files’ that the performance counting registers are being written to are closed at the system being monitored.
(37) In some implementations, jump to the basic-block containing the exit instruction or equivalent at the system being monitored.
   Processing (which includes “Aggregator” and “Consumer”)

### Aggregator

(38) In some implementations, States are ingested from the Gneiss agent (sometimes referred to herein as “on-device agents”) by the aggregator.
(39) In some implementations, the aggregator runs a socket server (or anything that receives information from the systems being monitored) listening indefinitely (example only; other communication methods can be supported).
(40) In some implementations, the system being monitored reaches out over the communication channel to establish connection at the aggregator at the analysis server.
(41) In some implementations, a task is created to read from that listening entity at (39) in a loop.
(42) In some implementations, when data is received at the aggregator of the analysis server, a state_hash is generated to simplify the collection of States from the same processes on the same device.
(43) In some implementations, the state_hash is calculated by XOR-ing the SHA-256 hash of the process id (PID) with the SHA-256 hash of the device id.
(44) In some implementations, once the state_hash is added, the State is sent to a queue to be held for assessment.

### Consumer (at the Analysis Server)

(45) In some implementations, the States of a process are collected and linked into a StateFlow to be robustly assessed.
(46) In some implementations, a data structure, such as an unordered map, using the state_hash as the lookup key and the StateFlow as the value, is created.
(47) In some implementations, the FlowCustodian is run in a separate thread to manage the data structure in (46) by tracking expiration and completion of collected StateFlows.
(48) In some implementations, the FlowCustodian (47) creates a connection to a columnar database, which will retain a history of recently run processes.
(49) In some implementations, when the FlowCustodian finds a complete or expired entry, the FlowCustodian loops through its StateFlow (to ensure that everything is correctly ordered, there is no data corruption, and/or the like) and adds it to the database.
(50) In some implementations, the consumer reads the queue configuration file to connect the queue configuration file to the correct queue.
(51) In some implementations, signal handling is configured to handle unexpected interrupts and terminations.
(52) In some implementations, a queue consumer is created using the configurations from (50).
(53) In some implementations, a State is consumed from the queue.
(54) In some implementations, the message containing the State is processed by a switch case; if there is no error, the State in the message is passed to a function that appropriately inserts the data into the assembler data structure.
(55) In some implementations, the Flow Custodian searches the assembler data structure to see if the entry matches with an existing flow.
(56) In some implementations, if a flow with a matching hash already exists, add the State to that flow.
(57) In some implementations, if there is no match, create a new entry with the hash values as the key.
(58) In some implementations, update the FlowController and refresh the time to live (TTL) for that particular flow.

### Alerting

(59) In some implementations, the StateFlows are not ingested from the database but received in duplicate from the assembler. Data source does not affect detection or alerting.
(60) In some implementations, the alerting system reads a configuration (e.g., a configuration file), directing it to the database.
(61) In some implementations, a notice will be generated if the completed StateFlow is malformed due to transmission errors.
(62) In some implementations, code is added to handle the edge cases and additional steps to reduce total malformed StateFlows further.
(63) In some implementations, depending on the processor, different numbers of HPCs will be available. The counter fields not used in the State structs will be dropped, as they will be empty.
(64) In some implementations, the detector calculates the difference between each counter in each sequential State.
(65) In some implementations, the detector then calculates statistical values for each State for later use: mean, median, standard deviation, z-scores, multivariate Mahalanobis distance, and/or the p-value of the Mahalanobis distance.
(66) In some implementations, each State is compared against the equivalent State for all process models, created in lines (79)-(90), that the StateFlow may match.
(67) In some implementations, the models are used to predict if that State is anomalous compared to intended and normal device execution.

### System in Training Phase

In some implementations, the training system generates device execution models (sometimes referred to herein as “models”) for assessment. In some implementations, a user (e.g., integration engineer) onboards new sensors/hardware by connecting the devices that will execute and generate the models in the training system. In some implementations, the user will access, via their user device, the training system user interface (UI) to fetch the code to instrument and start the training process. In some implementations, the training system receives and/or retrieves the source code (e.g., un-instrumented code) and version to characterize on the devices. In some implementations, an instrumenter will compile the source code with the Gneiss instrumentation (code that is injected into the compiled code) on the device. In some implementations, the Instrumentation System (system that takes the un-instrumented source, instruments the un-instrumented source, then loads the instrumented source onto the device for testing and/or execution) will send the instrumented code to a device execution engine. In some implementations, an input fuzzer will use execution guided by data and control flow to ensure complete coverage of a plurality of pathways (e.g., to achieve a coverage objective), such as substantially all (e.g., 100%, at least 99%, at least 98%, at least 95%, and/or the like) possible pathways and, thus, substantially all possible execution states. In some implementations, the input fuzzer will interact with a code patcher to ensure sequences execute realistically and efficiently. In some implementations, a patched and instrumented binary will go to a device loader, which will install the updated firmware onto the device for generating models. In some implementations, sensors, embedded systems, and/or control units under test will be loaded with the adjusted firmware and run numerous times, generating telemetry. In some implementations, a telemetry aggregator receives the telemetry data from the sensors/hardware and hashes it before delivering it to a message queue. The message queue guarantees the delivery of the hashed telemetry to a flow assembler. In some implementations, the flow assembler combines individual states into StateFlows for analysis and dispatches the StateFlows to a columnar database that holds the history of StateFlows from training cycles. In some implementations, a model generator will access the hashed training telemetry in the columnar database and generate models of each state in each StateFlow for testing and validation. In some implementations, the sensors/hardware will run through known good and bad scenarios (e.g., good as in correct code operating correctly on a correctly operating device; bad as in any number of permutations of the code where one or more things are incorrect (e.g., as discussed below at (90)); a model assessor will record the results. In some implementations, a result database records the results, which are then represented to the user through a training system user interface after completion.

In some implementations, an input generator (e.g., an input fuzzer) uses execution guided by dataflow and/or control-flow information to exercise a plurality of execution pathways of the instrumented code according to a coverage objective. Said similarly, the plurality of pathways can be determined based on a coverage objective. The exercised plurality of pathways can include, for example, representative pathways, high-likelihood pathways, and/or pathways determined as significant to safety, security, or functional correctness. In some implementations, the coverage objective is determined with respect to one or more measurable coverage metrics (e.g., basic-block, edge, branch, call-graph, and/or dataflow-constraint coverage) and can correspond to high coverage (e.g., at least 95%, at least 98%, at least 99%, and/or approaching full coverage) of at least one such metric, thereby producing a corresponding plurality of execution states for modeling.

In some implementations, the training system includes the following components and/or performs the following functions, which can be implemented in hardware and/or software: (1) device characterization; (2) instrumentation; (3) on-device operation; (4) processing; (5) model building; (6) model assessment. Note that steps (68) to (91) below are described for the device characterization, instrumentation, on-device operation, processing, model building, and model assessment, but do not indicate a strict ordering; said differently, the sequence of (68) to (91) can be followed in one implementation, but the sequence for performing (68) to (91) can vary in other implementations.

### Device Characterization

(68) In some implementations, before instrumentation, a “dataflow coverage map” (sometimes referred to herein as “map”) will be generated by collecting the constraints of each individual basic block.
(69) In some implementations, execution paths with their dataflow constraints are recorded utilizing principles of control flow analysis.
(70) In some implementations, a modified fuzzer will use this additional information to execute a plurality of (e.g., substantially all) pathways of the device, and guide execution to generate operation normal States by deploying tweaked firmware versions. This ensures enough StateFlow telemetry is received to develop reliable and complete models for all execution pathways.
(71) In some implementations, the source code is acquired from source control (e.g. Git®) or another manufacturer supported method to run the Characterizer.
(72) In some implementations, configure correctly provisioned and prepared devices to run in the test environment to ensure correct StateFlow telemetry collection.
(73) In some implementations, guide execution by combining dataflow and a coverage guided fuzzer with additional instrumentation to ensure correct execution of various States (execute device characterizer).

### Instrumentation

(74) In some implementations, the process for instrumenting the code in a training context is the same as in a live environment. Lines (1)-(7) describe instrumentation.

### On Device Operation

(75) In some implementations, the on-device operation is the same as in a live environment. The description can be found on lines (12)-(37).

### Processing

(76) In some implementations, the processing sequence mirrors the description described in lines (38)-(58).
(77) In some implementations, substantially (e.g., at least 90%, at least 95%, at least 99%, and/or the like) all device output is captured as State telemetry that will be used to generate the models.

### Model Building

(78) In some implementations, the alerting system reads the configuration file directing it to the database.
(79) In some implementations, the detector reads from the database to gather the execution information that will be used to build the models.
(80) In some implementations, if the completed StateFlow is malformed due to transmission errors, a notice will be generated.
(81) In some implementations, malformed flows can be assessed for cause and tuning or pruning so as not to disrupt the correct version of the model.
(82) In some implementations, depending on the processor, there will be different numbers of HPCs that are available. The counter fields not used in the State structs can be dropped, as they affect processing without adding value.
(83) In some implementations, the detector calculates the difference between each counter in each sequential State.
(84) In some implementations, the detector then calculates statistical values for each State that will be used later: mean, median, standard deviation, z-scores, multivariate Mahalanobis distance, and/or the p-value of the Mahalanobis distance.
(85) In some implementations, the detector uses loops through the States of the collection of StateFlows.
(86) In some implementations, a rough contamination measure is calculated to account for outliers in execution to inform the training of the model.
(87) In some implementations, a support-vector machine running stochastic gradient descent is trained in the collection of all matching States for that execution path.
(88) In some implementations, possible process parentage is documented with the processes and their flows.
(89) In some implementations, further detection heuristics are used.

### Model Assessment

(90) Test the model against devices running correctly, malware, software errors, and hardware issues to generate a confusion matrix to prove sufficiency.
(91) Test different HPCs for improved strength of signal as needed. This would occur as a preparation step executing lines (73) & (74) in small samples ahead of (75), long term execution of the device.

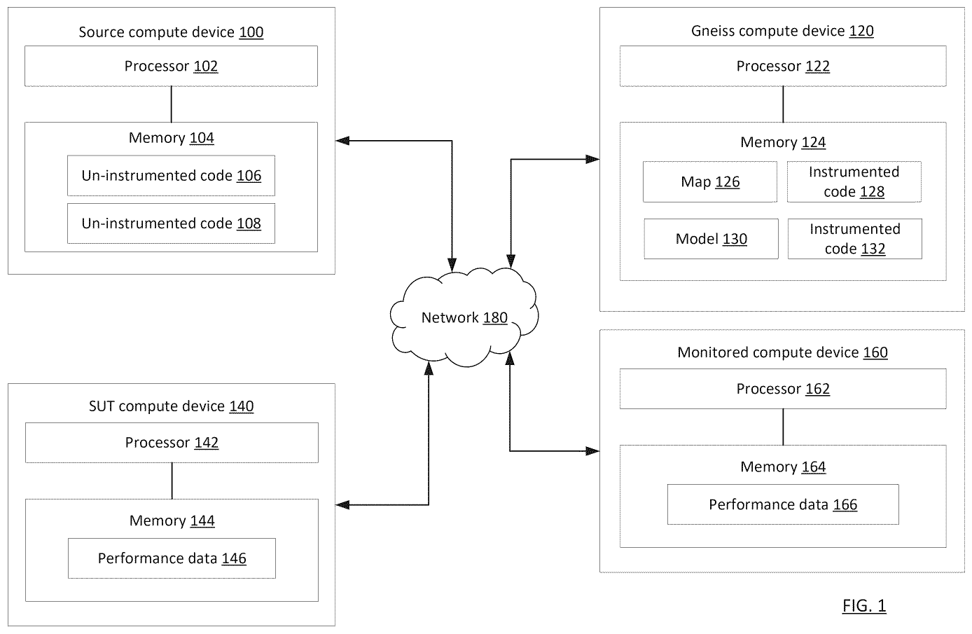

FIG. 1 illustrates a system block diagram of a system that can use performance data to prove correct and intended execution of code and code pathways on a device, according to an embodiment. FIG. 1 includes source compute device 100, Gneiss compute device 120, system under test (SUT) compute device 140, and monitored compute device 160, each operatively coupled to one another via network 180.

Network 180 can be any suitable communications network for transferring data, operating over public and/or private networks. For example, network 180 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 180 can be a wireless network such as, for example, a Wi-Fi or wireless local area network (“WLAN”), a wireless wide area network (“WWAN”), and/or a cellular network. In other instances, network 180 can be a wired network such as, for example, an Ethernet network, a digital subscription line (“DSL”) network, a broadband network, and/or a fiber-optic network. In some instances, the network can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via network 180 can be encrypted or unencrypted. In some instances, the network 180 can include multiple networks or subnetworks operatively coupled to one another by, for example, network bridges, routers, switches, gateways and/or the like (not shown).

Source compute device 100 includes processor 102 operatively coupled to memory 104 (e.g., via a system bus), and can be any type of compute device, such as a server, desktop, laptop, tablet, mobile device, and/or the like. Gneiss compute device 120 includes processor 122 operatively coupled to memory 124 (e.g., via a system bus), and can be any type of compute device, such as a server, desktop, laptop, tablet, mobile device, and/or the like. SUT compute device 140 includes processor 142 operatively coupled to memory 144 (e.g., via a system bus), and can be any type of compute device, such as a server, desktop, laptop, tablet, mobile device, and/or the like. Monitored compute device 160 includes processor 162 operatively coupled to memory 164 (e.g., via a system bus), and can be any type of compute device, such as a server, desktop, laptop, tablet, mobile device, and/or the like. In some implementations, SUT compute device 140 and/or monitored compute device 160 is a sensor. In some implementations, SUT compute device 140 and monitored compute device 160 are the same type of sensor.

Processors 102, 122, 142, and/or 162 can be, for example, a hardware-based integrated circuit (IC), or any other suitable processing device configured to run and/or execute a set of instructions or code. For example, processors 102, 122, 142, and/or 162 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processors 102, 122, 142, and/or 162 can be configured to run any of the methods and/or portions of methods discussed herein. In some implementations, processors 142 and 162 have the same processor architecture and/or are the same type of processor.

Memories 104, 124, 144, and/or 164 can be, for example, a random-access memory (RAM), a memory buffer, a hard drive, a read-only memory (ROM), an erasable programmable read-only memory (EPROM), and/or the like. In some instances, memories 104, 124, 144, and/or 164 can store, for example, one or more software programs and/or code that can include instructions to cause processors 102, 122, 142, and/or 162, respectively, to perform one or more processes, functions, and/or the like. In some implementations, memories 104, 124, 144, and/or 164 can include extendable storage units that can be added and used incrementally. In some implementations, memories 104, 124, 144, and/or 164 can be portable memories (e.g., a flash drive, a portable hard disk, and/or the like) that can be operatively coupled to processors 102, 122, 142, and/or 162, respectively. In some instances, memories 104, 124, 144, and/or 164 can be remotely operatively coupled with a compute device (not shown).

FIG. 1 illustrates the system that can have a training phase and an execution (inference) phase, according to an embodiment. During the training phase, a model is generated using system under test (SUT) compute device 140. The model represents performance data collected from known-good, fully characterized devices (e.g., SUT compute device 140), similar to a ground truth or baseline. Thus, during the execution phase, code executed at a system being monitored (e.g., monitored compute device 160) is used to generate performance data that is compared against the model (that was generated previously during the training phase) to check whether the code executed at the system under test is authentic, correct, and/or executed as intended.

### Training Phase

In some implementations, during a training phase, un-instrumented code 106 is sent from source compute device 100 to Gneiss compute device 120 via network 180. In response to receiving un-instrumented code 106, Gneiss compute device 120 instruments un-instrumented code 106 to generate instrumented code 128. Additionally or alternatively, in response to receiving un-instrumented code 106, Gneiss compute device 120 generates map 126 based on un-instrumented code 106 and/or instrumented code 128, as discussed at (68) to (73). Map 126 can represent a collection of inferences and constraints that, if followed, allow guided execution to different parts of instrumented code 128. Said differently, map 126 is used to obtain/promote coverage of a plurality of, such substantially all (e.g., 100%, at least 99%, at least 95%, and/or the like) possible, executions of a system under test including a processor and/or processor architecture identical to processor 142 of SUT compute device 140.

Map 126 and/or instrumented code 128 is then sent from Gneiss compute device 120 to SUT compute device 140 via network 180. Then, based on map 126 and instrumented code 128, SUT compute device 140 executes a plurality of executions (e.g., substantially all possible executions) to generate performance data 146. Performance data 146 can represent telemetry data associated with processor 142 as SUT compute device 140 executes instrumented code 128 using the plurality of pathways (e.g., substantially all possible executions) (as outlined in map 126). In some implementations, performance data 146 is represented as a StateFlow(s). SUT compute device 140 can then send performance data 146 to Gneiss compute device 120. In response to receiving performance data 146, Gneiss compute device 120 generates model 130 based on performance data 146, as discussed at (78) to (89). Gneiss compute device 120 can also test model 130, as discussed at (90) and (91). Model 130 can include at least one state associated with performance data 146, at least one flow associated with linked states representing an execution pathway of a process, and/or at least one data structure used to determine if the at least one flow is within a predetermined set of acceptable parameters. The at least one state can be, for example, a datagram(s) containing telemetry information. The at least one flow can be, for example, a linked state(s) representing an execution pathway of a particular execution pathway of a process. The at least one data structure can be, for example, any kind of appropriate container that holds the information used to determine if a process's flow is within acceptable parameters.

Upon generating and testing model 130, model 130 can act as a reference/standard so that any subsequent performance data generated by a system being monitored (e.g., monitored compute device 160) can be compared against model 130 and/or performance data 146 to see if the instrumented code that generated the subsequent performance data meets the standard of model 130 and/or performance data 146.

### Execution (Inference) Phase

After model 130 has been generated, model 130 can be used in the execution (inference) phase. For example, un-instrumented code 108 can be sent from source compute device 100 (or a compute device not shown in FIG. 1) to Gneiss compute device 120. Gneiss compute device 120 can then instrument un-instrumented code 108 to generate instrumented code 132 (e.g., using the same technique used to generate instrumented code 128 from un-instrumented code 106), as discussed at (1)-(7). Instrumented code 132 is then sent from Gneiss compute device 120 to monitored compute device 160. Monitored compute device 160 executes instrumented code 132 to generate performance data 166. Performance data 166 can represent telemetry data associated with processor 162 as monitored compute device 160 executes instrumented code 132. Performance data 166 can then be sent from monitored compute device 160 to Gneiss compute device 120. In response to receiving performance data 166, Gneiss compute device 120 determines a status of instrumented code 132 based on model 130 and performance data 166. Because instrumented code 132 is an instrumented version of un-instrumented code 108, un-instrumented code 108 has the same status as instrumented code 132. For example, if the status of instrumented code 132 is that instrumented code 132 is not authentic, the status of un-instrumented code 108 is also not authentic. As another example, if instrumented code 132's status is not operating as intended, un-instrumented code 108's status is also not operating as intended.

In some implementations, the status indicates whether instrumented code 132 (and by extension un-instrumented code 108) is authentic, operating as intended, correct, and/or in an error state (e.g., to detect malware, incorrect code versions, improperly operating devices, error pathways, and/or the like). In some implementations, “authentic” refers to instrumented code 132 being genuine and not tampered with or altered. In some implementations, “operating as intended” refers to instrumented code 132 functioning according to its specified requirements and design without material issues or deviations. In some implementations, “correct” refers to instrumented code 132 producing expected results and performing intended tasks substantially accurately, without material errors or bugs. In some implementations, “in an error state” refers to instrumented code 132 encountering problems or malfunctions that prevent instrumented code 132 from executing correctly or achieving its intended functionality. In some implementations, the status indicates that instrumented code 132 (and by extension un-instrumented code 108) includes an anomaly (e.g., tampering, malware, etc.). In some implementations, the anomaly is detected by comparing the states observed during process execution with the pre-developed model of process execution. Because the training stage and the live stages are separate, a determination can be made whether the instrumented code is inauthentic as the model would be built on authentic code.

In some implementations, values stored at a processor (e.g., processor 102, 122, 142, and/or 162) are stored in the processor's registers until the values are cleared or overwritten. While these values can survive after power-off, this data is no longer reliably accessed. After the device (e.g., source compute device 100, Gneiss compute device 120, SUT compute device 140, and/or monitored compute device 160) is powered back on, the values can change as soon as any of the boot process that users the process runs.

In some implementations, a remedial action is performed in response to determining that instrumented code 132 and/or un-instrumented code 108 are not authentic, are not operating as intended, are not correct, and/or are in an error state. In some implementations, the remedial action includes causing a processor (e.g., processor 102, 122, 142, and/or 162) to stop executing and/or instrumenting code (e.g., un-instrumented code 106, un-instrumented code 108, instrumented code 128, and/or instrumented code 132). In some implementations, the remedial action includes modifying (e.g., by processor 102, 122, 142, and/or 162) code (e.g., un-instrumented code 106, un-instrumented code 108, instrumented code 128, and/or instrumented code 132) to create updated code that is authentic, operating as intended, correct, and/or not in an error state. In some implementations, the remedial action includes causing a device (e.g., source compute device 100, Gneiss compute device 120, SUT compute device 140, and/or monitored compute device 160) to change of a mode of operation (e.g., shut off, enter sleep mode, reboot/restart, etc.). In some implementations, the remedial action includes causing a device (e.g., source compute device 100, Gneiss compute device 120, SUT compute device 140, and/or monitored compute device 160) to run a security response (e.g., begin logging data, enable a firewall, etc.). In some implementations, the remedial action includes causing a device (e.g., source compute device 100, Gneiss compute device 120, SUT compute device 140, and/or monitored compute device 160) to enter into a halt-or safe-state, where the device stops executing code (e.g., un-instrumented code 106, un-instrumented code 108, instrumented code 128, and/or instrumented code 132), enters into a safe state (e.g., such that only predetermined essential operations or diagnostic routines are executed), and/or disables high-risk interfaces (e.g., turning on hardware write-protect, disabling USB ports, disabling interfaces, etc.). In some implementations, the remedial action includes isolating a device (e.g., source compute device 100, Gneiss compute device 120, SUT compute device 140, and/or monitored compute device 160) from network traffic and placing the device in a virtual quarantine zone. In some implementations, the remedial action includes blocking a command path at a device (e.g., source compute device 100, Gneiss compute device 120, SUT compute device 140, and/or monitored compute device 160) such that only a predetermined trusted maintenance or engineering user device is permitted to communicate with the device and all other inbound or outbound connections to the device are blocked. In some implementations, the remedial action includes capturing (e.g., storing in memory) information that otherwise could disappear on reboot or shut down, such as RAM contents, current processes, active user sessions, open network connections, temporary files or uncommitted memory, and/or the like, to preserve evidence for later investigation and/or assisting in restoring operations (e.g., forensic processes and/or chain of custody); this information can be collected in a predetermined order of priority such that data that is of lower priority is not collected if collecting that data extends exposure time beyond a predetermined acceptable threshold. In some implementations, the remedial action includes swapping a device (e.g., source compute device 100, Gneiss compute device 120, SUT compute device 140, and/or monitored compute device 160) out with a replacement, substitute device. In some implementations, the remedial action includes installing trusted and/or pre-approved backup code. In some implementations, the remedial action includes applying a security patch, re-flashing firmware, rolling back to a previous clean version of the software, and/or the like. In some implementations, the remedial action includes identifying, collecting, and/or moving the anomalous code or behavior into an isolated test environment where users (e.g., engineers, computer scientists, programmers, etc.) can analyze for root cause. In some implementations, the remedial action includes post-incident hardening, such as updating security policies, modifying authentication or code-signing processes, modifying monitoring and detection systems, modifying patch management, and/or the like. In some implementations, any of the remedial actions discussed herein be performed in sequence and/or in parallel.

FIG. 1 illustrates an example, and other implementations can exist. For example, although FIG. 1 illustrates four compute devices, in other implementations, more or less compute devices can be used. For example, any of the functionalities described with respect to source compute device 100, Gneiss compute device 120, SUT compute device 140, and monitored compute device 160 can be merged into a lesser compute of compute devices and/or split across a larger number of compute devices. For example, SUT compute device 140 and monitored compute device 160 can be the same compute device in some implementations. As another example, un-instrumented code 106 can be stored at Gneiss compute device 120, SUT compute device 140, and/or monitored compute device 160.

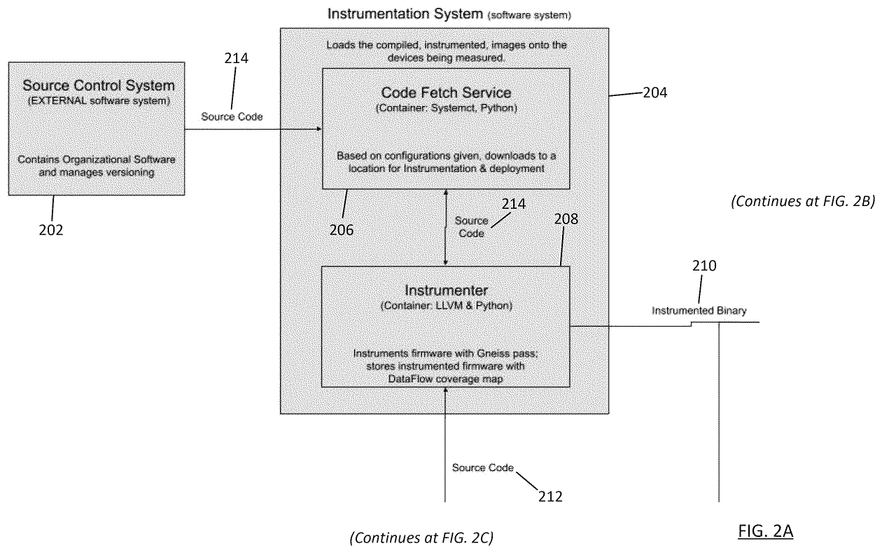

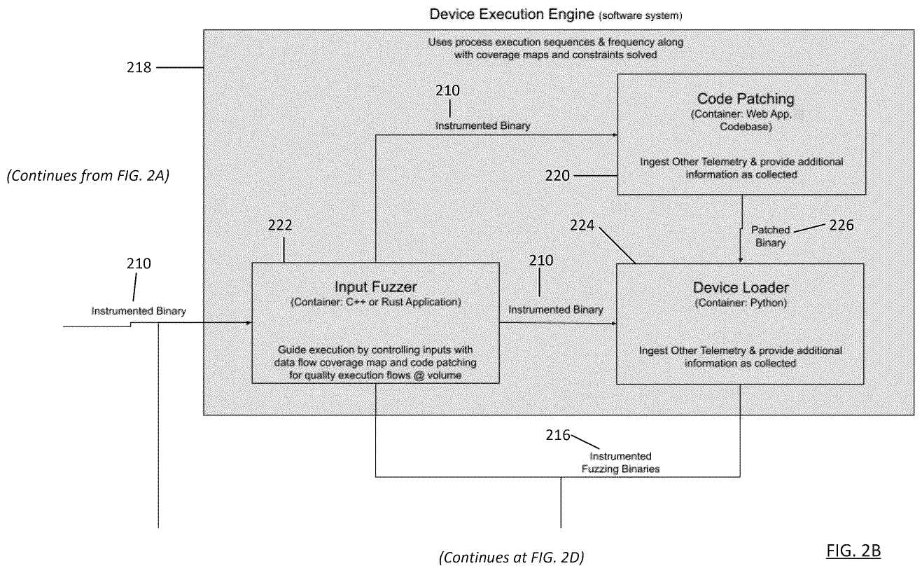

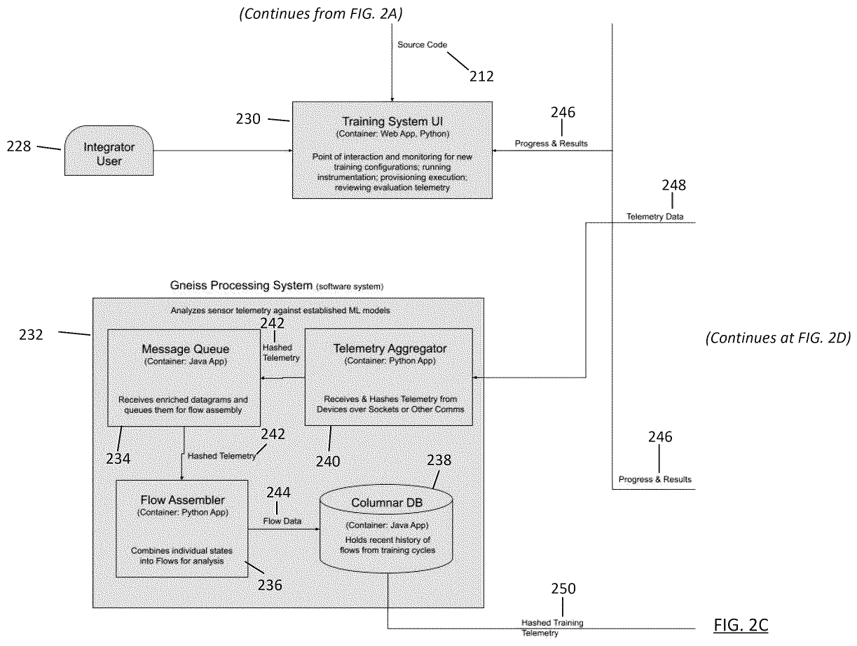

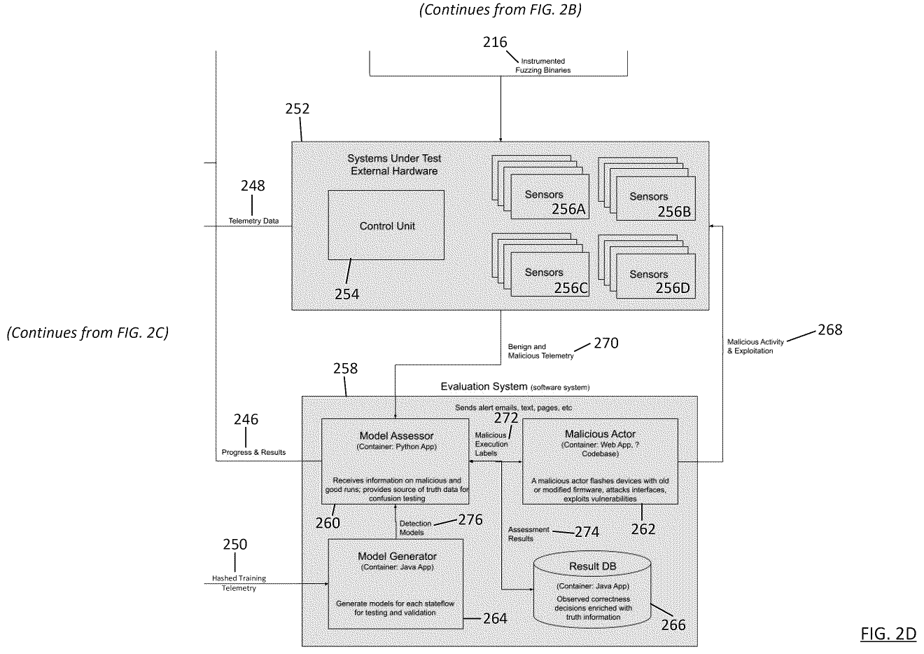

FIGS. 2A-2D illustrate a block diagram of a training system, according to an embodiment. Source control system 202 can be an external software system (e.g., source compute device 100 in FIG. 1) that contains organization software and manages versioning. Code fetch service 206 included in instrumentation system 204 can retrieve source code 214 from source control system 202 (e.g., source compute device 100 in FIG. 1). Instrumentation system 204 is part of a software system (e.g., on Gneiss compute device 120 in FIG. 1) and loads compiled, instrumented images onto the device being measured. Code fetch service 206 can include/be a software component. Code fetch service 206 can download to a location for instrumentation and deployment based on configurations given. Source code 214 can be sent between code fetch service 206 and instrumenter 208. Instrumenter 208 can include/be, for example, a compiler/other code instrumentation tool LL VM or another software component. Instrumenter can instrument firmware with Gneiss pass and store instrumented firmware with a DataFlow coverage map. In some implementations, instrumenter 208 is configured to perform the dataflow analysis.

Instrumented binary 210 can be sent from instrumenter 208 to input fuzzer 222 of device execution engine 218 (see FIG. 2B). Device execution engine 218 is part of the software system and uses process execution sequences and frequency along with coverage maps and constraints solved. Input fuzzer 222 can include/be, for example, a software component running as an application, service, or similar. Input fuzzer 222 can guide execution by controlling inputs with a data flow coverage map and code patching for quality execution flows at volume. Instrumented binary 210 can be sent from input fuzzer 222 to code patching 220 and device loader 224. Code patching 220 can include/be, for example, a software component. Code patching 220 can ingest other telemetry (e.g., information from input fuzzer 222 about updating the patching) and provide additional information as that information is collected. Code patching 220 can send patching binary 226 to device loader 224. Device loader 224 can include/be, for example, a software component. Device loader 224 can ingest and combine the instrumented binary and the patching information, then load the combined instrumented binary and patching information onto the devices.

Instrumented fuzzing binaries 216 can be sent from device loader 224 to system under test external hardware 252 (see FIG. 2D). System under test external hardware 252 can include control unit 254 and sensors 256A, 256B, 256C, 256D. Systems under test external hardware 252 can send a representation of telemetry (e.g., telemetry from either benign or malicious execution) to model assessor 260 of evaluation system 258. Evaluation system 258 can be part of the software system and perform actions such as sending alert emails, tests, pages, and/or the like. Model assessor 260 can include/be, for example, a software application or any other application, service, or code that performs the model assessor's 260 actions. Model assessor 260 can receive information on malicious and good runs (e.g., authentic executions, correct executions, etc.) and provide source of truth data for confusion testing to compare true positive, false positive, true negative, and false negative values. Model assessor 260 can receive detection models 276 from model generator 264. Model generator 264 can include/be, for example, a software component. Model generator 264 receives hashed training telemetry 250 from columnar DB 238 (see FIG. 2C) and generates models for each StateFlow for testing and validation. Malicious execution labels 272 can be exchanged between model assessor 260, and malicious actor 262. Malicious actor 262 can include, for example, a web application or codebase. Malicious actor 262 can flash devices with old or modified firmware, attack interfaces, and/or exploit vulnerabilities. Model assessor 260 and/or malicious actor 262 can send assessment results 274 to result database (DB) 266. Result DB 266 can include/be, for example, a software component. Result DB 266 can observe correctness decisions enriched with truth information. Malicious actor 262 can also send a representation of malicious activity and exploitation 268 to systems under test external hardware 252. Model assessor 260 can also send progress and results 246 to training system UI 230 (see FIG. 2C). Systems under test external hardware 252 can also send telemetry data 248 to telemetry aggregator 240 (see FIG. 2C).

Integrator user 228 can be a user and can use training system user interface (UI) 230. Training system UI 230 can include/be, for example, a software application or component. Training system UI 230 can be a point of interaction and monitoring for new training configurations. Training system UI 230 can run instrumentation, provision execution, and review evaluation telemetry. Gneiss processing system 232 can be part of the software system and analyze sensor telemetry against established ML models. Message queue 234 can include/be, for example, a software application component. Message queue 234 can receive enriched datagrams and queue them for flow assembly. Telemetry aggregator 240 can include/be, for example, a software component that receives and manages telemetry data over any communications channel to produce desirable/useful telemetry 242. Flow assembler 236 can include, for example, a software component. Flow assembler 236 can receive hashed telemetry 242 and combine individual states into flows for analysis. Flow data 244 can be sent from flow assembler 236 to DB 238. DB 238 can include/be, for example, a software component. DB 238 holds (e.g., stores) recent history of flows from training cycles.

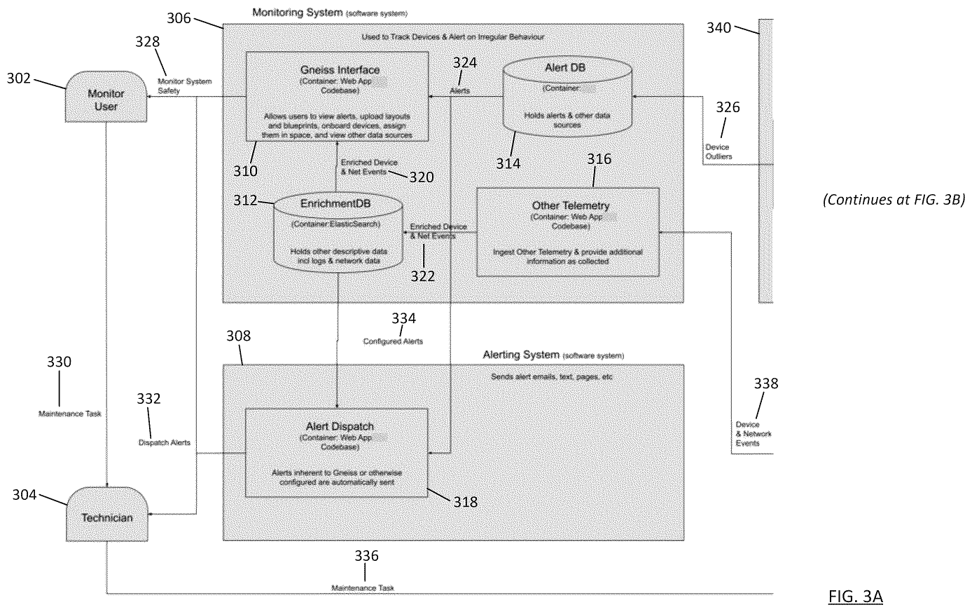

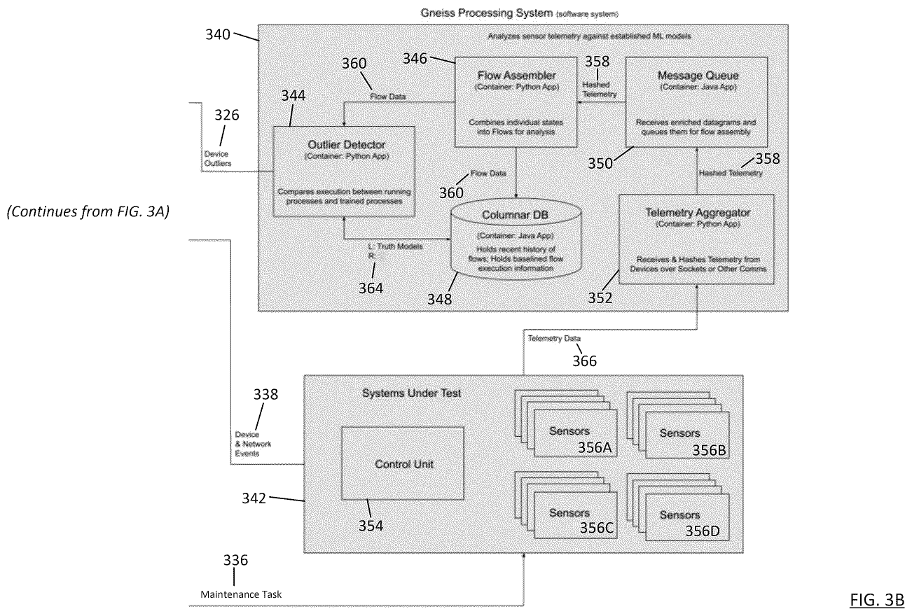

FIGS. 3A-3B illustrate a block diagram of a system during inference phase, according to an embodiment. Monitor system 306 can be part of the software system. Monitor system 306 can track devices and provide alerts for irregular behaviors. Gneiss interface 310 can include, for example, a software application or codebase. Gneiss interface 310 allows users to view alerts, upload layouts and blueprints, onboard devices, assign devices in space, and view other data sources. Gneiss interface 310 can receive enriched device and net events 320 from enrichment DB 312 and received alerts from alert DB 314. Enrichment DB 312 includes, for example, a docker (e.g., ElasticSearch) container. Enrichment DB 312 can hold (e.g., store) other descriptive data including logs and network data. Alert DB 314 can hold (e.g., store) alerts and other data sources. Alert DB 314 can receive device outliers 326 from outlier detector 344 (see FIG. 3B). Other telemetry 316 can include, for example, an application. Other telemetry 316 can ingest logs, alerts, and telemetry other than processor state telemetry. Other telemetry 316 can send enriched device and network events 322 to enrichment DB 312. Other telemetry 316 can receive device and network events 338 from system under test 342. Although FIGS. 3A-3B illustrate enrichment DB 312, in other implementations, a different storage can be used (e.g., a datastore, a search index, a database service, and/or the like).

Alerting system 308 can be part of the software system. Alerting system 308 can send alert emails, texts, pages, and/or the like. Alert dispatch 318 can include/be, for example, a software component. Alert dispatch 318 can automatically send alerts generated by anomalous states (e.g., outlier detector 344) or otherwise configured (e.g., alerts generated based on executing a normal error pathway and/or other log information extracted from the device). Alert dispatch 318 can receive configured alerts 334 from enrichment DB 312 and/or alert DB 314. Monitor system safety 328 and/or dispatch alerts 332 can be sent to a compute device(s) of monitor user 302 and/or technician 304. Maintenance task 330 can be sent from monitor user 302 to technician 304. Technician 304 can send maintenance task 336 to system under test 342 (see FIG. 3B).

Gneiss processing system 340 can be part of the software system and analyze sensor telemetry against established ML models. Outlier detector 344 can include/be, for example, a software component. Outlier detector 344 can compare execution between processes executed at the system under test and processes in the ground truth. Flow assembler 346 can include/be, for example, a software component. Flow assembler 346 can combine individual states into flows for analysis. Flow assembler 346 can send flow data 360 to outlier detector 344 and columnar DB 348. Columnar DB 348 can include/be, for example, a software component. Columnar DB 348 can hold (e.g., store) recent history of flows and/or baselined flow execution information. Columnar DB 348 can receive flow data 360 from flow assembler 346. The outlier detector 344 may reference truth models 364, which can be stored in a Columnar DB 348. Message queue 350 can include/be, for example, a software component. Message queue 350 can receive enriched datagrams and queue them for flow assembly. Message queue 350 can send processed telemetry 358 to flow assembler 346. Telemetry aggregator 352 can include/be, for example, a software component. Telemetry aggregator 352 can receive, hash, and otherwise process telemetry from devices over communication channels to produce hashed telemetry 358. Telemetry aggregator 352 can send hashed telemetry 358 to message queue 350.

Systems under test 342 can send telemetry data 366 to telemetry aggregator 352. Systems under test 342 can include control unit 354 and sensors 356A, 356B, 356C, and 356D.

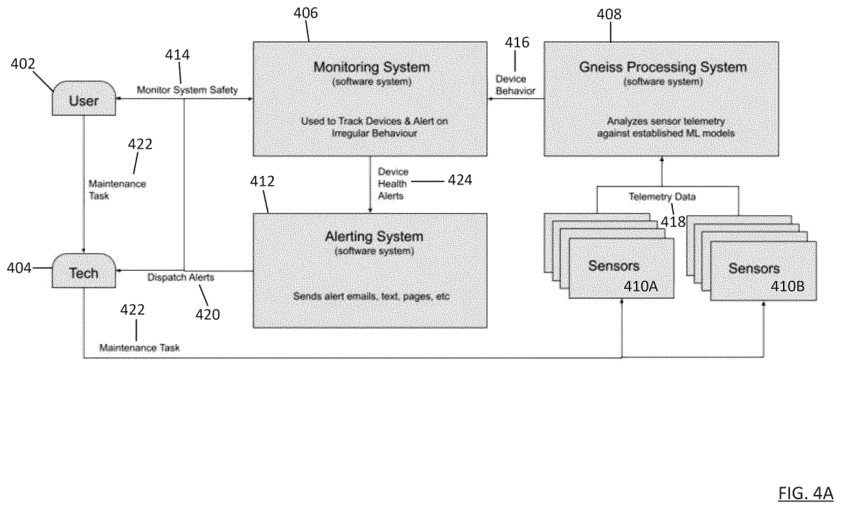

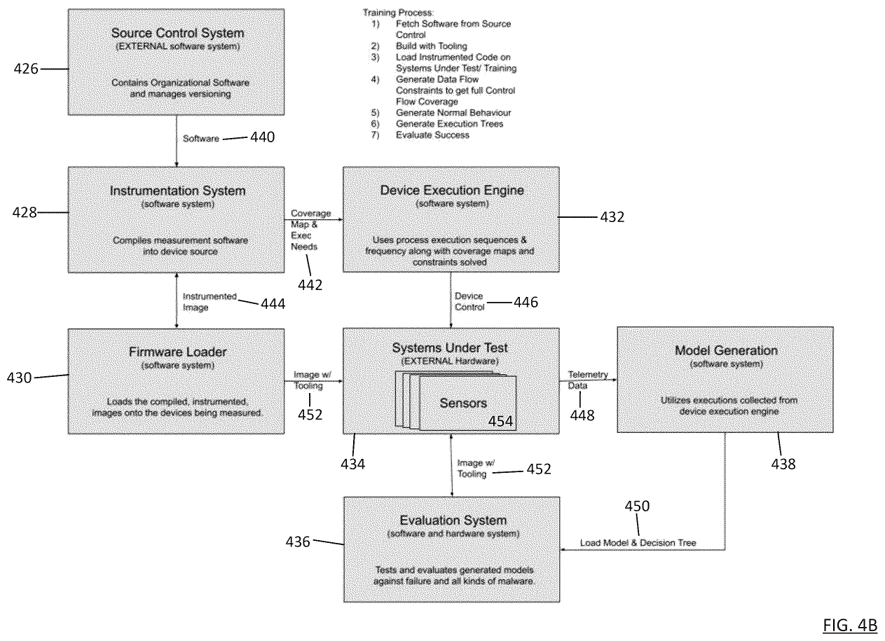

FIGS. 4A-4B illustrate system block diagrams of a system during an inference phase and training phase, according to an embodiment. FIG. 4A illustrates a block diagram of a live system, according to an embodiment. Monitoring system 406 can be part of a software system (e.g., Gneiss compute device 120 of FIG. 1). Monitoring system 406 can track devices and alerts on irregular behaviors. Gneiss processing system 408 can be part of the software system. Gneiss processing system 408 can analyze sensor telemetry against established ML models. Gneiss processing system 408 can send device behavior 416 to monitoring system 406. Sensors 410A and 410B can send telemetry data 418 to Gneiss processing system 408. Alerting system 412 can be part of the software system and send alerts, emails, texts, pages, and/or the like. Alerting system 412 can send dispatch alerts 420 and/or monitor system safety 414 at user 402 and/or tech 404. Monitoring system 406 can send and/or receive dispatch alerts 420 and/or monitor system safety 414 to and/or from user 402 and/or tech 404. User 402 can send maintenance task 422 to tech 404 and tech 404 can send maintenance task 422 to sensors 410A and 410B.

FIG. 4B illustrates a block diagram of a system during a training phase, according to an embodiment. Source control system 426 can be part of an external software system. Source control system 426 can include and/or execute, for example, device code, organization software, and version management. Instrumentation system 428 can retrieve software and firmware 440 from the source control system 426. Instrumentation system 428 can be part of the software system and compile measurement software into a device source. Instrumentation system 428 can send coverage map and execution constraints 442 (e.g., coverage map and execution instructions/directions/guidance) to device execution engine 432. Instrumentation system 428 can also send to and/or receive from firmware loader 430 instrumented image 444. Device execution engine 432 can be part of the software system and execute using process execution sequences, frequency, coverage maps, and/or constraints solved. Device execution engine 432 can send device control 446 to systems under test 434. Firmware loader 430 can be part of the software system. Firmware loader 430 loads the compiled, instrumented images onto the devices being measured. Firmware loader 430 sends image with tooling 452 (i.e., instrumentation) to systems under test 434. Systems under test 434 is part of external hardware and includes sensors 454. Systems under test 434 can send telemetry data 448 to model generation 438. Systems under test 434 can exchange image with tooling 452 (i.e., instrumented device code) with evaluation system 436. Model generation 438 is part of the software system and uses executions collected from device execution engine 432. Model generation 438 sends load model and decision tree 450 to evaluation system 436. Evaluation system 436 is part of the software and hardware system. Evaluation system 436 tests and evaluates generated models against failure and one or more kinds of malware. In some implementations, a training process includes: (1) fetching software from source control; (2) building with tooling; (3) loading instrumented code on systems under test/training; (4) generating data flow constraints to get full control flow coverage; (5) generating normal behavior; (6) generating execution trees; and (7) evaluating success.

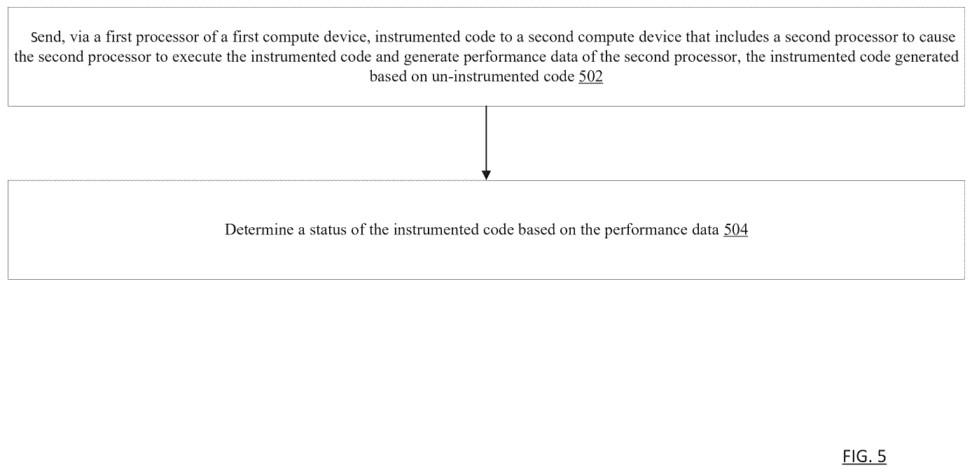

FIG. 5 illustrates a flowchart of a method 500 to determine a status of instrumented code, according to an embodiment. In some implementations, method 500 is performed by a processor (e.g., processor 120). In some implementations, method 500 is performed at a basic block level of the processor. In some implementations, “basic block” refers to a straight-line code sequence with no branches in, except to the entry, and no branches out, except at the exit.

At 502, instrumented code (e.g., instrumented code 132) is sent, via a first processor (e.g., processor 122) of a first compute device (e.g., Gneiss compute device 120), to a second compute device (e.g., monitored compute device 160) that includes a second processor (e.g., processor 162) to cause the second processor to execute the instrumented code and generate performance data (e.g., performance data 166) of the second processor. The instrumented code is generated based on un-instrumented code (e.g., un-instrumented code 108).

At 504, a status of the instrumented code is determined based on the performance data. In some implementations, the un-instrumented code can/would experience the same (or substantially similar) disruptions as the instrumented code. In some implementations, the un-instrumented code does not have the status and interruptions of the instrumented code.

In some implementations of method 500, the status indicates that the instrumented code is at least one of (e.g., all of) (1) authentic, (2) operating as intended, (3) correct, or (4) not in an error state.

In some implementations of method 500, the first processor is further configured to detect an anomaly associated with the instrumented code. The anomaly associated with the instrumented code indicates that the un-instrumented code includes the anomaly (and/or that the second compute device as affected by something that would result in an anomaly).

In some implementations of method 500, the status is further determined based on a model (e.g., model 130) that includes at least one state.

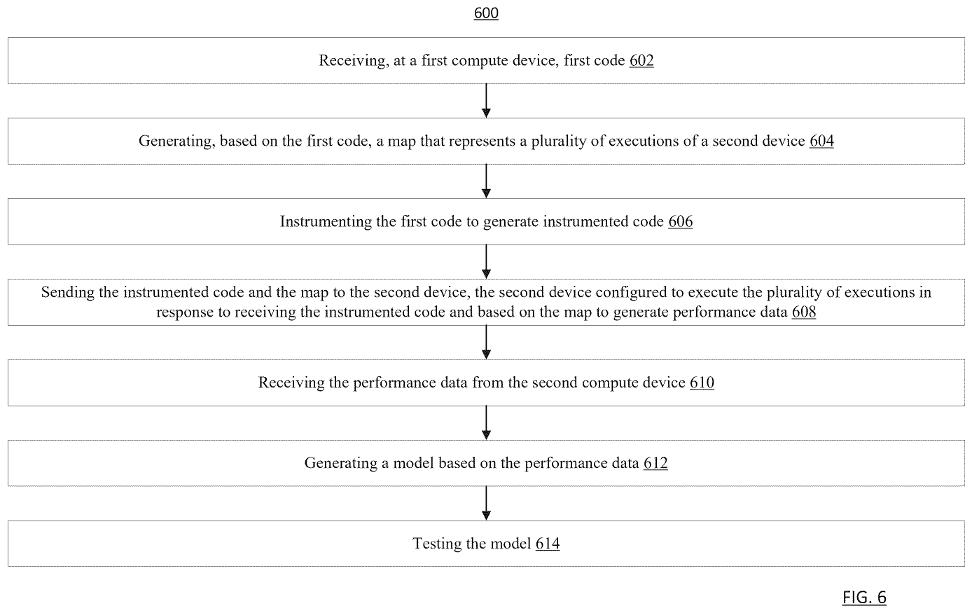

FIG. 6 shows a flowchart of a method 600 to generate a model, according to an embodiment. In some implementations, method 600 is performed by a processor (e.g., processor 120). In some implementations, method 600 is performed at a basic block level of the processor.

At 602, first code (e.g., un-instrumented code 106) is received at a first compute device (e.g., Gneiss compute device 120).

At 604, a map (e.g., map 126) that represents a plurality of executions of a second compute device (e.g., SUT compute device 140) is generated based on the first code.

At 606, the first code is instrumented to generate instrumented code (e.g., instrumented code 128).

At 608, the instrumented code and the map are sent to the second compute device. The second compute device is configured to execute the plurality of executions in response to receiving the instrumented code and based on the map to generate performance data (e.g., performance data 146).

At 610, the performance data is received from the second compute device.

At 612, a model (e.g., model 130) is generated based on the performance data.

At 614, the model is tested.

In some implementations of method 600, the first code is received from a third compute device (e.g., source compute device 100) that is different than the first compute device and the second compute device.

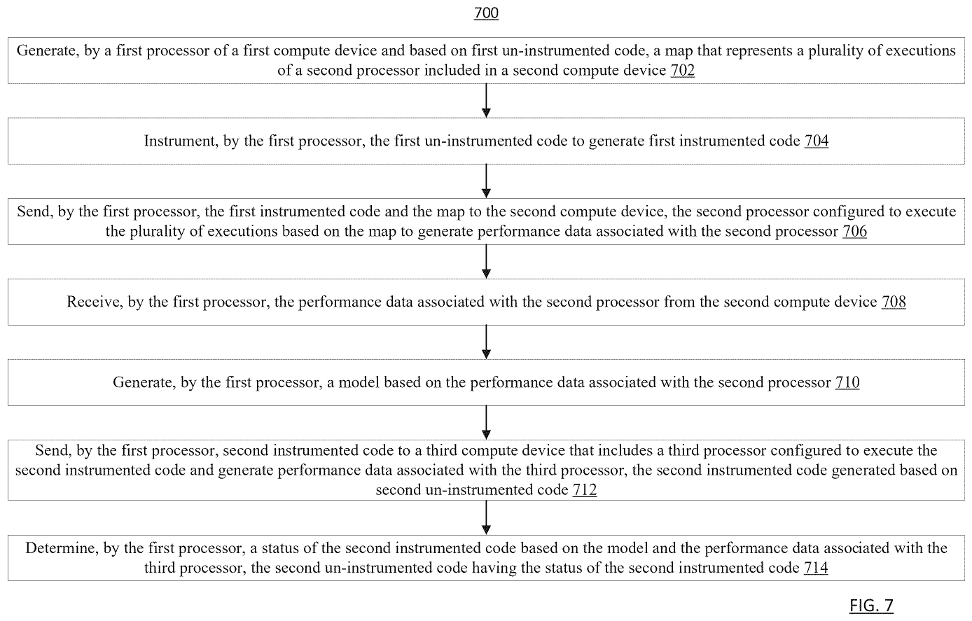

FIG. 7 illustrates a flowchart of a method 700 to generate and use a model, according to an embodiment. In some implementations, method 700 is performed by a processor (e.g., processor 122). In some implementations, method 700 is performed at a basic block level of the processor.

At 702, a map (e.g., map 126) is generated by a first processor (e.g., processor 122) of a first compute device (e.g., Gneiss compute device 120) based on first un-instrumented code (e.g., un-instrumented code 106). The map represents a plurality of executions (e.g., substantially all possible executions) of a second processor (e.g., processor 142) included in a second compute device (e.g., SUT compute device 140).

At 704, the first un-instrumented code is instrumented, by the first processor, to generate first instrumented code (e.g., instrumented code 128).

At 706, the first instrumented code and the map are sent, by the first processor, to the second compute device. The second processor is configured to execute the plurality of executions based on the map to generate performance data (e.g., performance data 146) associated with the second processor.

At 708, the performance data associated with the second processor is received by the first processor and from the second compute device.

At 710, a model (e.g., model 130) is generated by the first processor, based on the performance data associated with the second processor.

At 712, second instrumented code (e.g., instrumented code 132) is sent, by the first processor, to a third compute device (e.g., monitored compute device 160) that includes a third processor (e.g., processor 162) configured to execute the second instrumented code and generate performance data associated with the third processor. The second instrumented code is generated based on second un-instrumented code (e.g., un-instrumented code 108).

At 714, a status of the second instrumented code is determined, by the first processor, based on the model and the performance data associated with the third processor. The second un-instrumented code has the status of the second instrumented code.

In some implementations of method 700, the status indicates that the second instrumented code is at least one of authentic, operating as intended, correct, or not in an error state.

Some implementations of method 700 further include detecting an anomaly associated with the second instrumented code. The anomaly associated with the second instrumented code indicates that execution of the second instrumented code is anomalous. Some implementations of method 700 further include, in response to detecting the anomaly, performing a remedial action.

In some implementations of method 700, the plurality of executions include substantially (e.g., at least 90%, at least 95%, at least 98%, at least 99%) all possible executions of the second processor.

Some implementations of method 700 further include including, by a compiler (e.g., Low Level Virtual Machine compiler), a monitoring sequence to the first un-instrumented code to generate the first instrumented code.

In some implementations of method 700, the second compute device has a sensor type and the third compute device has the sensor type.

In some implementations of method 700, the second processor has a processor type and the third processor has the processor type. Examples of processor types include central processing units, graphics processing units, neural processing units, digital signal processors, application-specific integrated circuits, field-programmable gate arrays, and/or the like.

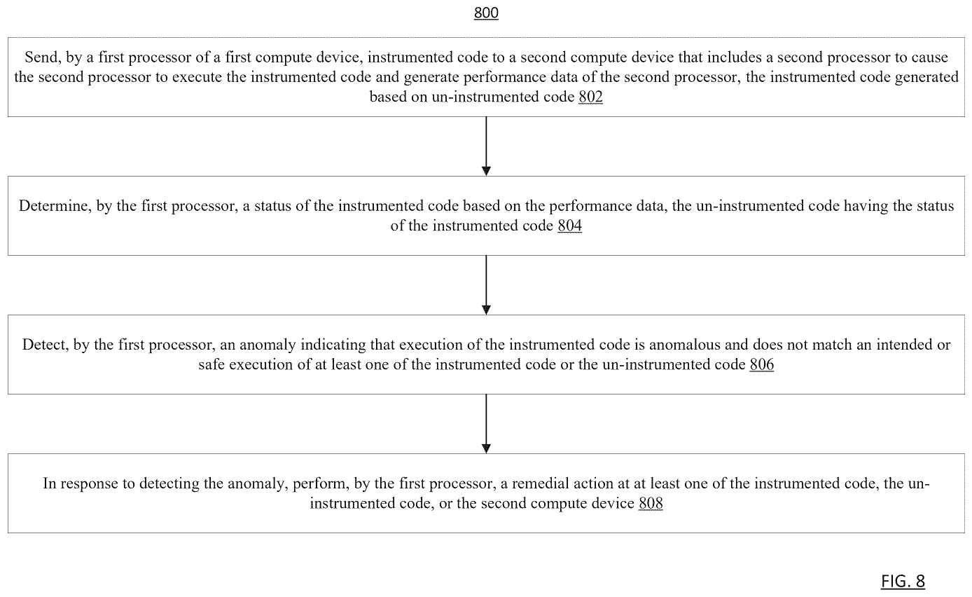

FIG. 8 illustrates a flowchart of a method 800 to perform a remedial action in response to detecting an anomaly, according to an embodiment. In some implementations, method 800 is performed by a processor (e.g., processor 122). In some implementations, method 800 is performed at a basic block level of the processor.

At 802, instrumented code (e.g., instrumented code 132) is sent, by a first processor (e.g., processor 122) of a first compute device (e.g., Gneiss compute device 120), to a second compute device (e.g., monitored compute device 160) that includes a second processor (e.g., processor 162) to cause the second processor to execute the instrumented code and generate performance data (e.g., performance data 166) of the second processor. The instrumented code is generated based on un-instrumented code (e.g., un-instrumented code 108).

At 804, a status of the instrumented code is determined, by the first processor, based on the performance data. The un-instrumented code has the status of the instrumented code.

At 806, an anomaly indicating that execution of the instrumented code is anomalous and does not match an intended or safe execution of at least one of the instrumented code or the un-instrumented code is detected by the first processor.

At 808, in response to detecting the anomaly, a remedial action is performed, by the first processor, at at least one of the instrumented code, the un-instrumented code, or the second compute device.

In some implementations of method 800, the status indicates that the instrumented code is at least one of not authentic, not operating as intended, incorrect, or in an error state.

In some implementations of method 800, the remedial action includes modifying the instrumented code or the un-instrumented code to mitigate the anomaly.

In some implementations of method 800, the remedial action includes causing the second compute device to pause execution of the instrumented code.

Some implementations of method 800 further include receiving the un-instrumented code from a third compute device (e.g., source compute device 100). Some implementations of method 800 further include instrumenting the un-instrumented code to generate the instrumented code.

Some implementations of method 800 further include receiving the un-instrumented code from a third compute device (e.g., source compute device 100). Some implementations of method 800 further include including, using a compiler (e.g., Low Level Virtual Machine compiler), a monitoring sequence to the un-instrumented code to generate the instrumented code.

In some implementations of method 800, the status indicates that the instrumented code is in an error state.

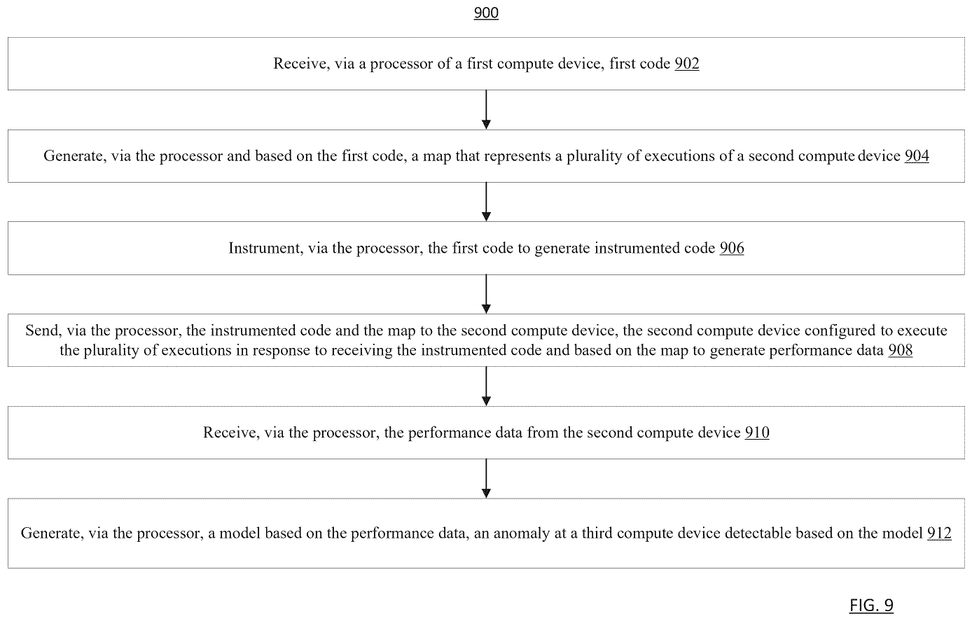

FIG. 9 illustrates a flowchart of a method 900 to generate a model based on performance data, according to an embodiment. In some implementations, method 900 is performed by a processor (e.g., processor 122). In some implementations, method 900 is performed at a basic block level of the processor.

At 902, first code (e.g., un-instrumented code 106) is received via a processor (e.g., processor 122) of a first compute device (e.g., Gneiss compute device 120).

At 904, a map (e.g., map 126) that represents a plurality of executions of a second compute device (e.g., SUT compute device 140) is generated via the processor and based on the first code.

At 906, the first code is instrumented, via the processor, to generate instrumented code (e.g., instrumented code 128).

At 908, the instrumented code and the map are sent, via the processor, to the second compute device. The second compute device is configured to execute the plurality of executions in response to receiving the instrumented code and based on the map to generate performance data (e.g., performance data 146).

At 910, the performance data is received, via the processor, from the second compute device.

At 912, a model (e.g., model 130) is generated, via the processor, based on the performance data. An anomaly at a third compute device (e.g., monitored compute device 160) is detectable based on the model.

In some implementations of method 900, the first code is received from a third compute device (e.g., source compute device 100) that is different than the first compute device and the second compute device.

In some implementations of method 900, the model includes (1) at least one state associated with the performance data and (2) linked states representing an execution pathway of a process.

Some implementations of method 900 further include determining that a processor state associated with the third compute device is outside predetermined acceptable parameters based on the model. Some implementations of method 900 further include performing a remedial action in response to determining that the processor state associated with the third compute device is outside the predetermined acceptable parameters.

In some implementations of method 900, the plurality of executions includes substantially all possible executions of the second compute device.

Some implementations of method 900 further include adding, via the processor and using a compiler (e.g., Low Level Virtual Machine compiler), a monitoring sequence to the first code to generate the instrumented code.

In some implementations of method 600, the model includes at least one state built from/based on telemetry data. Further, sequential states may represent a process execution pathway. Method 600 can further include determining if the telemetry data as a state or sequence of states is within predetermined acceptable parameters. In some implementations, the model is an aggregation and merging of multiple models for all of the process execution pathways (StateFlows) possible on the second compute device in a searchable manner.

In some implementations of method 600, the model includes at least one state associated with telemetry data, and linked states represent an execution pathway of a process. Some implementations of method 600 further include determining if a processor state is outside predetermined acceptable parameters. In some implementations, the model is an aggregation and merging of multiple models for all of the StateFlows on the second compute device in a searchable manner.

All combinations of the foregoing concepts and additional concepts discussed herein (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

1. A non-transitory, processor-readable medium storing code that, when executed by a first processor of a first compute device, causes the first processor to:
generate, based on first un-instrumented code, a map that represents a plurality of executions of a second processor included in a second compute device;
instrument the first un-instrumented code to generate first instrumented code;
send the first instrumented code and the map to the second compute device, the second processor configured to execute the plurality of executions based on the map to generate performance data associated with the second processor;
receive the performance data associated with the second processor from the second compute device;
generate a model based on the performance data associated with the second processor;
send second instrumented code to a third compute device that includes a third processor configured to execute the second instrumented code and generate performance data associated with the third processor, the second instrumented code generated based on second un-instrumented code; and
determine a status of the second instrumented code based on the model and the performance data associated with the third processor, the second un-instrumented code having the status of the second instrumented code.

2. The non-transitory, processor-readable medium of claim 1, wherein the status indicates that the second instrumented code is at least one of (1) authentic, (2) operating as intended, (3) correct, or (4) not in an error state.

3. The non-transitory, processor-readable medium of claim 1, wherein the code further includes code that, when executed by the first processor, cause the first processor to:
detect an anomaly associated with the second instrumented code, the anomaly associated with the second instrumented code indicating that execution of the second instrumented code is anomalous; and
in response to detecting the anomaly, perform a remedial action.

4. The non-transitory, processor-readable medium of claim 1, wherein the plurality of executions includes substantially all possible executions of the second processor.

5. The non-transitory, processor-readable medium of claim 1, wherein the code to instrument the first un-instrumented code to generate the first instrumented code includes code to:
include, by a compiler, a monitoring sequence to the first un-instrumented code to generate the first instrumented code.

6. The non-transitory, processor-readable medium of claim 1, wherein the second compute device has a sensor type and the third compute device has the sensor type.

7. The non-transitory, processor-readable medium of claim 1, wherein the second processor has a processor type and the third processor has the processor type.

8. A first compute device, comprising:
a memory; and
a first processor operatively coupled to the memory, the first processor configured to:
send instrumented code to a second compute device that includes a second processor to cause the second processor to execute the instrumented code and generate performance data of the second processor, the instrumented code generated based on un-instrumented code;
determine a status of the instrumented code based on the performance data, the un-instrumented code having the status of the instrumented code;
detect an anomaly indicating that execution of the instrumented code is anomalous and does not match an intended or safe execution of at least one of the instrumented code or the un-instrumented code; and
in response to detecting the anomaly, perform a remedial action at at least one of the instrumented code, the un-instrumented code, or the second compute device.

9. The first compute device of claim 8, wherein the status indicates that the instrumented code is at least one of (1) not authentic, (2) not operating as intended, (3) incorrect, or (4) in an error state.

10. The first compute device of claim 8, wherein the remedial action includes modifying the instrumented code or the un-instrumented code to mitigate the anomaly.

11. The first compute device of claim 8, wherein the remedial action includes causing the second compute device to pause execution of the instrumented code.

12. The first compute device of claim 8, wherein the first processor is further configured to:
receive the un-instrumented code from a third compute device; and
instrument the un-instrumented code to generate the instrumented code.

13. The first compute device of claim 8, wherein the first processor is further configured to:
receive the un-instrumented code from a third compute device; and
include, using a compiler, a monitoring sequence to the un-instrumented code to generate the instrumented code.

14. The first compute device of claim 8, wherein the status indicates that the instrumented code is in an error state.

15. A method, comprising:
receiving, via a processor of a first compute device, first code;
generating, via the processor and based on the first code, a map that represents a plurality of executions of a second compute device;
instrumenting, via the processor, the first code to generate instrumented code;
sending, via the processor, the instrumented code and the map to the second compute device, the second compute device configured to execute the plurality of executions in response to receiving the instrumented code and based on the map to generate performance data;
receiving, via the processor, the performance data from the second compute device; and
generating, via the processor, a model based on the performance data, an anomaly at a third compute device detectable based on the model.

16. The method of claim 15, wherein the first code is received from a third compute device that is different than the first compute device and the second compute device.

17. The method of claim 15, wherein the model includes (1) at least one state associated with the performance data and (2) linked states representing an execution pathway of a process.

18. The method of claim 15, further comprising:
determining that a processor state associated with the third compute device is outside predetermined acceptable parameters based on the model; and
perform a remedial action in response to determining that the processor state associated with the third compute device is outside the predetermined acceptable parameters.

19. The method of claim 15, wherein the plurality of executions includes substantially all possible executions of the second compute device.

20. The method of claim 15, further comprising:
adding, via the processor and using a compiler, a monitoring sequence to the first code to generate the instrumented code.
